(19) United States
(12) Patent Application Publication
(10) Pub. No.: US 2012/0173414 A1
(43) Pub. Date: Jul. 5, 2012

(54) METHOD AND SYSTEM FOR COMPUTER-BASED BIDIRECTIONAL PAY-PER-CLICK BIDDING AND MATCHING BETWEEN TWO COMPLEMENTARY POPULATION GROUPS

(76) Inventor: MARC ERFANI HOAG, Mill Valley, CA (US)

(21) Appl. No.: 13/342,944

(22) Filed: Jan. 3, 2012

Related U.S. Application Data
(60) Provisional application No. 61/429,064, filed on Dec. 31, 2010.

(51) Int. Cl. G06Q 30/06

(52) U.S. Cl. 705/39

(57) ABSTRACT

Computer-implemented systems and methods that enable matching people and/or entities while creating financial disincentives to prevent people and/or entities from over-marketing themselves to their counterparts. The system is implemented as a computerized pay-per-click matching system between two complementary population groups utilizing predefined generalized criteria and user-generated keywords with associated user-defined bid values.

### CROSS-REFERENCE TO RELATED APPLICATION

This regular U.S. patent application relies on and claims the benefit of priority under Title 35, United States Code, §119(e) to U.S. provisional patent application Ser. No. 61/429,064 filed on Dec. 31, 2010, which is incorporated by reference herein in its entirety.

### BACKGROUND OF THE INVENTION

1. Field of the Invention

This invention relates in general to methods and systems for providing a way to match people or other entities together via the Internet, and accessible by computers and mobile devices, for the purpose of engaging in mutually beneficial collaboration, while providing disincentives to prevent people or other entities from over-marketing themselves.

2. Description of the Related Art

In the current market, inefficient matching between members of complementary groups of people or entities, for example, without limitation, employers and employees; entrepreneurs and cofounders; entrepreneurs and attorneys or investors; producers and suppliers; people seeking new friends, or members of any other complementary groups of people or entities results in expenditure of substantial time and expense. This wasted time and cost is precipitated by human tendency to overvalue themselves. In the employer/employee-matching scenario, for example, this results in prospective employees submitting overly ambitious resumes and cover letters that are at best little more than marketing hyperbole, and at worst, ridden with inaccurate or even falsified information. In short, there is no incentive for people or entities to avoid false or misleading marketing of their skills or abilities. This results in tremendous time and cost inefficiencies associated with filtering through the unqualified yet over-marketed candidates.

Therefore, there is a need for systems and methods that create disincentives that prevent people or entities from over-marketing themselves.

### SUMMARY OF THE INVENTION

The inventive methodology is directed to methods and systems that substantially obviate one or more of the above and other problems associated with conventional techniques for matching people and/or other entities.

In accordance with one aspect of the present invention, there is provided a computerized system for matching a first entity from a first plurality of entities and a second entity from a second plurality of entities. The inventive system incorporates: a first user interface portion for receiving at least one general requirement; a second user interface portion for receiving at least one user-generated keyword being indicative of at least one characteristic of the first entity; a third user interface portion for receiving a bid value corresponding to the at least one user-generated keyword; a matching portion for generating a match results based on the general requirement, the at least one user-generated keyword and the bid value; and a connection establishing portion for establishing a connection between the first entity and the second entity using the match results, wherein upon stabling the connection, the first entity and the second entity are each automatically charged an amount of money based on the bid value.

In accordance with another aspect of the present invention, there is provided a computer-implemented method for matching a first entity from a first plurality of entities and a second entity from a second plurality of entities. The inventive method involves: generating a first user interface portion for receiving at least one general requirement; generating a second user interface portion for receiving at least one user-generated keyword being indicative of at least one characteristic of the first entity; generating a third user interface portion for receiving a bid value corresponding to the at least one user-generated keyword; generating a match results based on the general requirement, the at least one user-generated keyword and the bid value; and establishing a connection between the first entity and the second entity using the match results, wherein upon stabling the connection, the first entity and the second entity are each automatically charged an amount of money based on the bid value.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary result of various keyword subset universes that the inventive system may produce as part of the process in performing the designed and intended purpose.

FIG. 2 illustrates an exemplary operating sequence performed by an embodiment of the inventive system in relation to Providers and Seekers.

FIG. 3 illustrates an exemplary result of Providers and Seekers populating keywords into the same subset universe.

FIG. 4 illustrates an exemplary result of two Seekers' different degrees of match accuracy with a Provider's desired keywords within a subset universe as created by both Provider and the two Seekers.

FIG. 5 illustrates an exemplary demonstration of two Seekers selecting the same Provider and subsequently being submitted into the Provider's Applicant Pool.

FIG. 6 illustrates an exemplary embodiment of a computer platform upon which the inventive system may be implemented, and which may be used or accessed by various clients such as other computers, mobile devices, or other Internet-connected devices.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Various aspects of the present invention provide various computer-implemented systems and methods that enable matching between people and/or entities while creating financial disincentives to prevent people and/or entities from over-marketing themselves to their counterparts. As would be appreciated by those of skill in the art, the embodiments of the inventive systems and methods eliminate inefficiencies associated with conventional matching techniques.

For the purposes of the below disclosure, the following assumptions are made. Two general types of people exist in the world: Opportunity Providers and Opportunity Seekers, typically for example, but without limitation, employers and employee candidates, respectively. Alternative examples of Provider-Seeker pairs may include, without limitation: an entrepreneur building a new company (Provider of new opportunity) who is actively searching for cofounders (Seekers looking to join a new startup venture); entrepreneurs (Seekers) looking for the best investors or attorneys (Providers of financial and legal services, respectively) for their new startup; or investors or attorneys (Seekers of new financial or legal services opportunities) actively looking for the best startups (Providers of new legal services business and investment opportunities, respectively) for their portfolios; or non-professional “Provider/Seeker” pairs such as people seeking new friendship or relationship opportunities. Allowing Seekers to market themselves by bidding on keywords will best reflect their true skills, experience, education, personal qualities, etc. A colloquial expression provides a sound analogy: Seekers will essentially be required to “put their money where their mouth is.” All things being equal, the higher a Seekers' self-assigned bid values, the more visible that Seeker will appear to Providers in a search results list. Thus the cost associated with false marketing—and bidding—is a financial penalty equal to: (1) the sum of the matching keywords' bids that triggered the match between Provider and Seeker in the first instance; (2) the reduced seeker reliability based on a reduced rating in the bidding database; and (3) associated loss of time and money as a direct result of the false marketing. The benefit of this system is that this trio of risks associated with false marketing will result in the highest bidders typically being the most perfect match for a particular opportunity.

### Exemplary Scenario

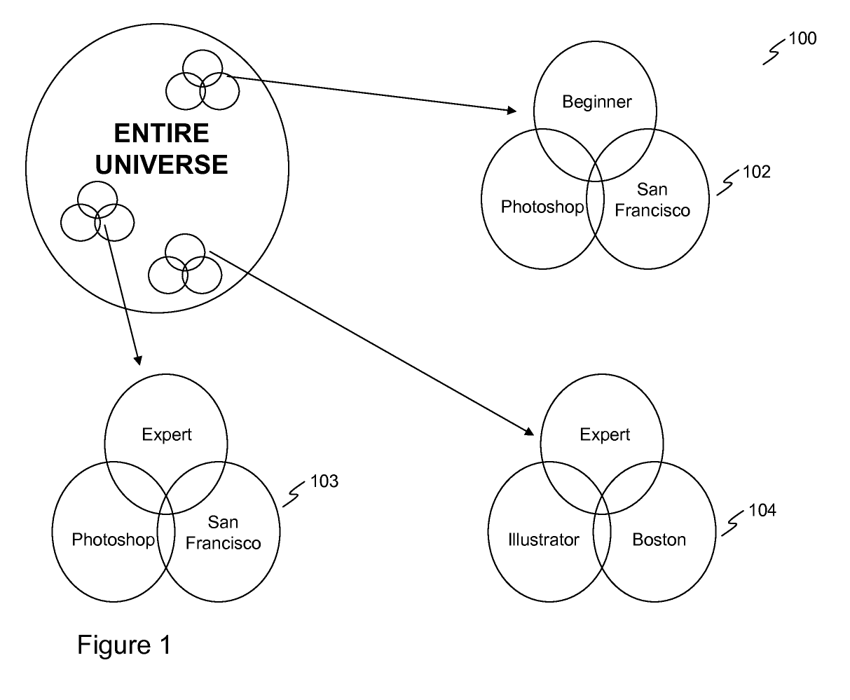

In one exemplary illustrative scenario, in accordance with one or more embodiments of the invention, the system may perform the following steps 100, illustrated in FIG. 1: A provider, an employer, is seeking an advanced graphics designer with superb Photoshop skills 102. Seeker 1 (“S1”) and Seeker 2 (“S2”) both apply for the position. S1 is a superb artist, but has never used Photoshop 103. S2 is a superb artist with years of experience with Photoshop 102. S1's resume and cover letter are superior to S2's so Provider first sets up an interview with 51 only to immediately discover S1's utter incompetency for the position due to S1's unfamiliarity with Photoshop, which S1 failed to disclose. Both Provider and S1 have now lost time and money during the course of this transaction. Using systems and methods of various embodiments of the invention, however, S1 will be unable to market himself as an advanced graphics designer with Photoshop skills: if S1 were to outbid all competitor Seekers, S1 would both (1) lose the money used to outbid the competitor Seekers, (2) still be without a job and (3) receive a low rating from Provider, reducing S1's reliability rating. Accordingly, S1 will not seek Provider's opportunity; Provider will discover S2 who appropriately outbid S2's competitor Seekers; and Provider and S2 will therefore be perfectly matched and able to connect. Thus, systems and methods of various embodiments of the invention produce an effective disincentive for Seekers like S1 to over-market themselves to Providers.

### DESCRIPTION OF EXEMPLARY EMBODIMENTS

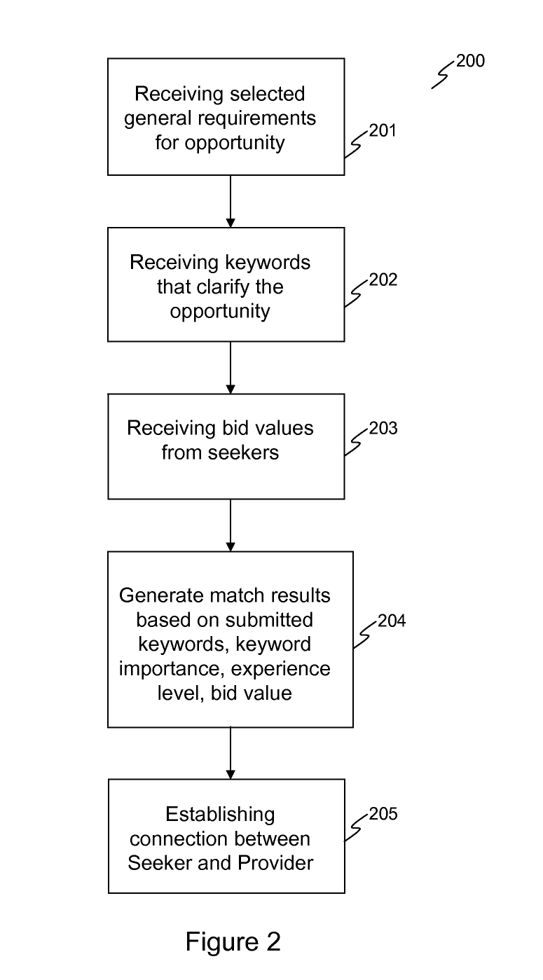

In accordance with one or more embodiments of the invention, the system may perform the following steps 200, illustrated in FIG. 2, in relation to Providers and Seekers: there is provided a computerized pay-per-click matching system and method for matching members of two complementary population groups utilizing predetermined generalized criteria and user-generated keywords with associated user-defined bid values. In particular, one or more embodiments of the inventive system may include one or more of the following three general components:

(1) General Criteria System, “GCS”: At step 201, in accordance with one or more embodiments of the invention, GCS may include a user interface portion for receiving from the user a selection of certain criteria. In one or more exemplary embodiments, GCS may include a drop-down menu or a similar user interface as commonly used in computer software and Internet web browsers, each menu pertaining to a general category of criteria, for example, without limitation, “Location,” “Experience,” “Minimum Salary,” etc., and each drop-down menu containing several general options, for example, “West Coast,” “Intermediate,” “$100,000 or higher,” respectively, that allows for the creation of subset universes of possible keywords which thereby affects the range of possible bid values of such keywords as the supply-and-demand point of equilibrium may be changed, as described in detail below.

(2) Keyword Bidding System with Importance Ranking (“KBS”): At step 202, in accordance with one or more embodiments of the invention, KBS is a computerized system that utilizes both keyword bidding and keyword relative importance ranking, that employs dynamic pricing of user-generated keywords, where generally, bid value is proportional to number of individuals competing for the same keyword in the same subset universe (see Paragraph 0021 below), e.g., for Seeker S1 with no competitors, minimum required bid for maximum visibility to Providers is theoretically $0.00. For Seeker S2 with n competitors, minimum required bid bmin(S2) for maximum visibility to Providers is some value such that bmin(S2)>b(S1 . . . n).

In accordance with one or more embodiments of the invention, KBS is a variation of extant “pay-per-click” (“PPC”) payment systems and allows Seekers, S, to assign bid values to the keywords they submit. Typically, the higher the seeker's S bid value, the more immediately visible in match results seeker S may appear. For example, seekers' S profiles triggered by keywords assigned a value of $5 may typically appear before keywords assigned a value of $4. The range of values required to promote keyword visibility may utilize a pure inverse supply-and-demand system. Thus for n=1 keyword systems, the minimum theoretical bid required to achieve the highest visibility would (theoretically) be $0. For n=2 keywords, k1 and k2, for the visibility v(k1)>v(k2) it must (typically) be the case that $k1>$k2.

In accordance with one or more embodiments of the invention, KBS is intimately linked with the results produced in GCS: the discrete values selected in GCS create a subset of the universe of possible keywords which thereby affects the range of possible bid values of such keywords as the supply-and-demand point of equilibrium may be changed. Specifically, there is an inverse relationship between number of keywords and required bid value to achieve maximum visibility, i.e., as keyword competition increases, the bid value is driven up.

One exemplary scenario illustrates this in general: consider keyword k in two different universes, U(m) and U(n), such that U(m)>U(n), in which there are k1 . . . kU(m) and k1 . . . kU(n) instances of k, respectively, as populated by m and n users, respectively. Because U(m)>U(n), this implies greater competition for k in U(m) than in U(n). Thus, this drives up the required bid value such that $kU(m)>$kU(n).

One concrete exemplary scenario further establishes this concept: if zero discrete categories were selected and S chose some non-unique keyword k, this particular k would be but one amongst a (potentially) infinite other k provided by other S. This would drive up the bid value of k to an infinite degree. If however S selected a discrete category that contained virtually no other competitor S submitting keyword k, then the bid value would now be driven down to nearly zero.

Thus, in accordance with one or more embodiments of the invention, all S have an incentive to be as specific as possible when selecting discrete options as a means of reducing the level of competition for their keywords and thus driving down the bid values accordingly. Similarly, this benefits P as well: the more specific the categories and related keywords, the more likely a perfect match and the lower the transactional cost for P to connect with S (see description below of the transaction costs).

In accordance with one or more embodiments of the invention, keyword entry may be performed, for example, without limitation, by keywords entered either one at a time or as a group using any typical data input system as commonly used in computer software and Internet web browsers such as text input fields or similar, allowing for the entry of user-generated keywords or strings of words, such keywords provided for the purpose of illustrating particular skillsets, experiences, personal qualities, etc., as though extracted from a résumé, e.g., “LAMP web developer” “PHP” “web developer” “team player” “dedicated” “work ethic” “communication skills,” etc.

In accordance with one or more embodiments of the invention, while providing a user interface for entering keywords, the system may display an illustration of a method for submitting the desired bid value associated with the keyword. An exemplary implementation of this feature may include a sliding scale or a similar graphical primitive for Seekers that provides a means of visualizing the current bid amount range for the particular keyword as resulting from the competition all other competitor Seekers. Any other similar method or system to assist seekers with best selecting a bid value may be alternatively implemented. In accordance with one or more embodiments of the invention, the seeker S selects the keyword bid value using the displayed sliding scale based on the displayed keyword bid amount range.

In accordance with one or more embodiments of the invention, another application of sliding scales or similar graphical primitives may be a method for qualifying the relative importance or experience level of a particular keyword or set of keywords for Providers. For example, a Provider who wants a Seeker who is first and foremost a web programmer may assign a high importance value to “web programmer” but may also like the candidate to have design skills with Photoshop, and thus assign a lower importance to “Photoshop.” Similarly, a Provider may indicate the desired experience level for each skill, as indicated on a graduated continuum with beginner at one extreme and expert at another.

(3) Keyword Matching System, “KMS”: At step 204, in accordance with one or more embodiments of the invention, the KMS operates in two stages. First, it considers the subset universe created by users' selection of options from the GCS, as illustrated by Elements 101, 102, and 103 of FIG. 1. Then, the KMS considers the keywords provided by both groups of population—e.g., Providers and Seekers—in the same subset universe created by the GCS and considers the assigned relative keyword importance. For example, if Provider selects options from the GCS that produce some subset universe SU1 in which Provider submits various keywords K1, the KMS looks to see which Seekers have (1) selected identical items from the GCS such that Seeker is now within SU1, and then (2) looks to see which of Seekers' keywords K2 match K1. The system then returns a results list (as described in greater detail below) to each Provider and Seeker at step 205 for whom the match has been produced and from which both parties may click to connect with one another.

### Exemplary Operating Sequence

In accordance with one or more embodiments of the invention, the system may perform the following steps 200, illustrated in FIG. 2, in relation to Providers and Seekers:

(1) GCS: At step 201, the GCS generates a user interface enabling both parties to select the general requirements for the opportunity offered and sought, respectively, and to receive the selected general requirements for the opportunity.

(2) KBS: At step 202, the KBS generates a user interface enabling both parties to submit keywords that best clarify the requirements for the opportunity offered and sought, respectively, and to receive the submitted keywords. Total number of keywords allowed may or may not be capped at some finite value and, in an embodiment, users may be allowed to add or suggest additional keywords. At step 203, using the generated user interface, seekers submit and the KBS receives bid values for each of their keywords proportional to their self-confidence about the particular keywords being marketed. The more Seekers compete for the same opportunity, the more expensive is the required bid to appear high on a list of returned matches. Meanwhile, the system generates a user interface enabling Providers to submit as many keywords as possible to best clarify the requirements needed to satisfy the opportunity they are providing and for which they are trying to attract the best qualified Seeker. Instead of receiving bid values for each keyword like Seekers, the system may enable Providers to assign an “importance value” or “desired experience level” to each keyword reflecting the relative necessity of one keyword compared to the others for that particular Provider's opportunity.

(3) KMS: At step 204, the KMS returns match results—Provider and Seeker limited public profiles (see Paragraph 0044 below for more) based upon parties' submitted keywords, keyword importance, experience level, bid value, or other criteria: Provider and Seeker limited public profiles (see Paragraph 0044 below for more) containing more important and higher bid keywords may typically appear before less important and lower bid keywords. A very important keyword may therefore appear before an unimportant, yet higher bid, keyword. A 100% perfect match exists when both parties submit the same type and number of keywords and all important keywords and experience levels are matched. Where multiple Seeker bidders submit the same bid value for the same keyword(s) with the same importance or experience levels, results list may be in decreasing order of keyword match percentage.

(4) Connection: In accordance with one or more embodiments of the invention, at step 205, both parties may access on the desired counterpart party's limited public profile (see description below for details on limited public profile) to connect with that party. At this point, both parties may pay a transaction fee equal to the bid value of the keyword that triggered the match in the first instance. Generally, the sum of the matching keywords' bids in a set of keywords that produced to the match as between both parties may determine the price. In accordance with one or more embodiments of the invention:

a. When Provider clicks on Seeker, the transaction occurs and both parties may connect with one another, i.e., be revealed each other's private profiles and contact information.

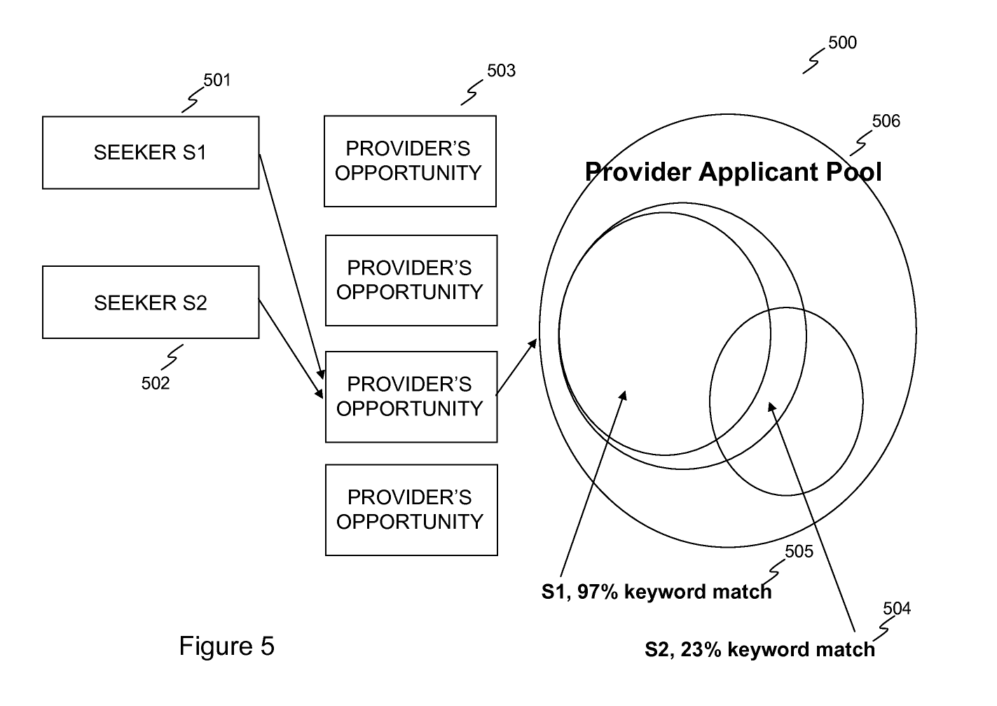

b. When Seeker clicks on Provider, Seeker is entered into Provider's Applicant Pool 506 shown in FIG. 5. Each Provider has its own Applicant Pool 506, a subset universe into which Seekers 501 and 502 are entered 504 and 505 upon clicking to connect with a Provider 503. Now the process continues again as Providers decide which Seeker to connect with from those Seekers in the Applicant Pool, Element 506 of FIG. 5.

(5) Rating System: In accordance with one or more embodiments of the invention, users may have the opportunity to rate members of the opposite group, e.g., Providers rating Seekers, or Seekers rating Providers. This allows one to be penalized for falsely marketing oneself and outbidding the competition, for example, and thereby serves as a reliability scale to other users' benefit. Users who have not yet been rated or new users who have not yet engaged in any transactions may start with a “null” or similar rating, so signified by an appropriately descriptive label such as “Not yet rated” or similar. User rating may be a percentage, letter grade, or similar, and may be calculated by a method best designed to reflect the particular user's reliability or quality as judged by others, for example, without limitation, the quotient obtained by dividing the number of total positive ratings by the sum of the total number of positive and negative ratings.

### Provider Steps

In accordance with one or more embodiments of the invention, the system may perform the following steps 200, generally illustrated in FIG. 2, in relation to enabling Providers to find and connect with their ideal Seeker candidates:

Step 1: GCS. At Step 201, The GCS may generate a user interface enabling the Provider to select from the GCS the various general requirements needed to be satisfied by a Seeker, for example, geographic location; minimum salary requirements; experience level; or any other general criteria. The system receives the Provider's selection using the generated user interface. The subset universe generated by the various menu options may produce the universe in which Seekers may compete (see the description below). For example, a Provider who selects “beginner” and “San Francisco” may create a subset universe that may be populated by different Seekers than the same Provider who selects “advanced” and “San Francisco,” as illustrated in FIG. 1.

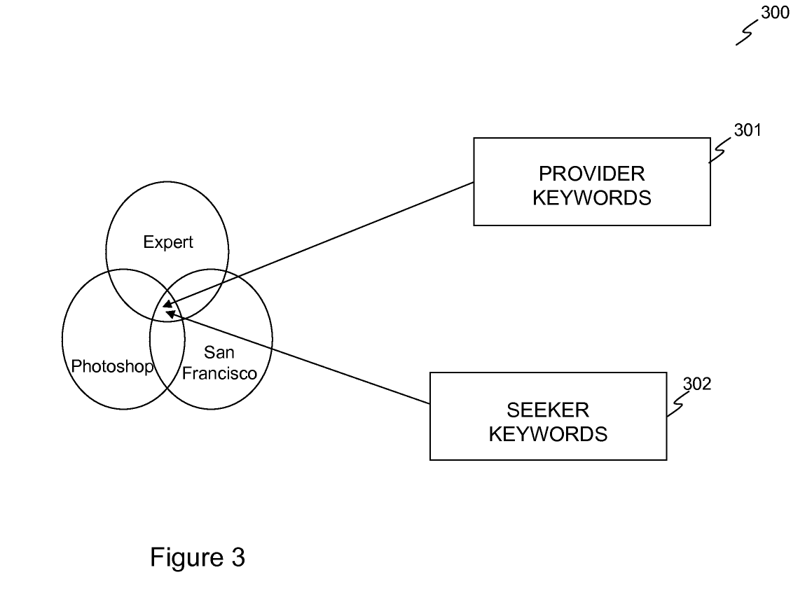

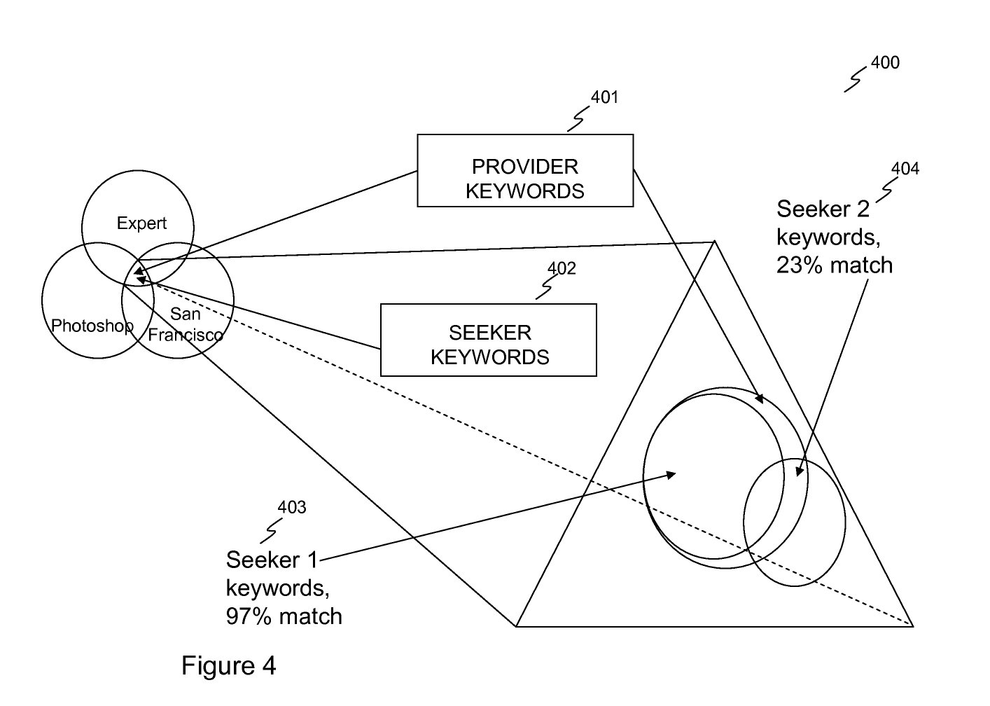

Step 2: KBS. At Step 202, the KBS generates a user interface enabling Provider to populate a list of keywords—maximum number of keywords allowed may or may not be capped at some finite value—into the KBS, such keywords populating only the subset universe generated by the above selected GCS. These keywords reflect the specific skills, experiences, personal qualities, etc. that the Provider desires in a prospective Seeker who may have also entered keywords into the same subset universe, as illustrated at 301 and 302 and 401 and 402 respectively for Provider and Seeker, of FIGS. 3 and 4. Provider may then assign a relative importance value to each keyword from a sliding scale or similar indicating importance of that particular keyword to the Provider. In one exemplary scenario, a horizontally displayed sliding scale or similar may illustrate a range of importance values with “0” at extreme left indicating “unimportant,” and “5” at extreme right indicating “extremely important,” and interim values of “1” “2” “3” and “4” accordingly representing increasingly more important values, respectively. A similar such sliding scale may allow for a selection of desired experience levels, with beginner at one extreme, and expert at the other. Provider may be able to either select a discrete value or slide a selector along the range of values to indicate desired importance value. Other similar methods and systems may also be employed, with varying value ranges, to achieve the same result.

Step 3: KMS. At step 204, having performed the above functions, the KMS may now perform a dynamic match between Providers' and Seekers' keywords. For a Provider with a set of submitted keywords {n} and Seeker with set of submitted keywords {m} a 100% perfect match exists when {n}={m}, and experience levels of {n} equal those of {m}, as illustrated in FIG. 4 elements 403 and 404.

Connection: In accordance with one or more embodiments of the invention, at step 205, Provider may now be presented with a list of relevant Seeker limited public profiles (see the description below) whose keywords match those of Providers within the same subset universe, which may ordered by keyword relative importance or match percentage and then by bid value. All things being equal, the KMS may be configured to ensure that a higher bid value for a more important keyword may typically appear before a lower bid value for the same equally important keyword. Similarly, a more important keyword may typically appear before a less important keyword even if the lower keyword is priced higher. In other words, keyword importance is typically more important than just raw bid value.

Alternatively, in accordance with one or more embodiments of the invention, a graphical “heat-map” type view may present Seekers' limited public profiles (see Paragraph 0044, below) upon a user-defined cartographical view of the world (or zoomed to a particular region), where higher-priced bidders appear more prominently (larger; brighter colors; etc.) than lower-priced bidders.

In accordance with one or more embodiments of the invention, only the following exemplary information may be available prior to clicking on a particular Seeker: small photo representative of the user; 160-character headline serving as a marketing tagline; user rating; keyword match accuracy percentage; location; desired work type (full-time, part-time, etc.), willing to commute/telecommute or relocate, etc.; bid value. In an attempt to combat fraud, an anti-fraud method and system may be implemented that may prevent users from including, for example, contact information in the small photo or 160-character headline. An exemplary scenario may include software algorithm(s) or alternative effective method(s) that recognize and disallow or otherwise disable any photos or 160-character headlines that include contact information such as telephone numbers, email addresses, or websites, such algorithms looking, for example, for images or text that take the form of numerals, characters, the “@” symbol or similar such as “(at)”, the prefix “www.” or suffix “.com” or “.net” or any other top-level Internet domain, or any other combination(s) thereof. Additionally, and in accordance with one or more embodiments of the invention, a function may allow Provider to click on a button on a Seeker's public listing that may cause the listing to “expand” or “unroll” and display a list that may display Seeker's keywords, their proficiency, importance, and relative match percentage, or other similar information.

Typically, in accordance with one or more embodiments of the invention, Provider may click the highest-priced bidder of the most important keywords on the premise that this must be the best candidate for the position. Upon clicking, a two-way transaction is processed: both Provider and Seeker pay the same transaction cost to the system. This two-way cost mirroring system serves three purposes: (1) it ensures Providers do not spam Seekers; (2) it ensures that Seekers—even legitimately qualified ones—do not excessively outbid the competition; and (3) it creates an incentive for Providers to consider Seekers 2 through n, on the premise that maybe a slightly lower-priced Seeker includes a superset of keywords to Provider's benefit, notwithstanding the lower price; otherwise, Seekers 2 through n would never be considered by Providers.

Step 4: Provider Review and Rating of Seeker. Once Provider has clicked on Seeker, Provider may now see all of Seeker's available information, including contact information.

Finally, in accordance with one or more embodiments of the invention, users may have the opportunity to rate members of the opposite group, e.g., Providers rating Seekers, or Seekers rating Providers. This allows one to be penalized for falsely marketing oneself and outbidding the competition, for example, and thereby serves as a reliability scale for other users' benefit. User rating may be a percentage, letter grade, or similar, and be calculated by a method best designed to reflect the particular user's reliability or quality as judged by others, for example, without limitation, the quotient obtained by dividing the number of total positive ratings by the sum of the total number of positive and negative ratings.

In accordance with one or more embodiments of the invention, all Providers and all Seekers begin with a “null” rating or “Not yet rated” label or similar, regardless of the type of system employed.

### Seeker Steps

In accordance with one or more embodiments of the invention, the system may perform the following steps 200, generally illustrated in FIG. 2, in relation to enabling Seekers to find and connect with the best Opportunity offered by a Provider:

Step 1: GCS. The GCS may generate a user interface enabling the Seekers to select from the GCS the various general requirements needed to be satisfied by a Provider, for example, geographic location; minimum salary requirements; experience level; or any other general criteria. The system receives the Seekers' selection using the generated user interface. The subset universe generated by the various menu options may produce the universe in which Providers may compete (see the description below). For example, a seeker who selects “beginner” and “San Francisco” may create a subset universe that may be populated by different Providers than the same Seeker who selects “advanced” and “San Francisco,” as illustrated in FIG. 1.

Step 2: KBS. Next, the KBS generates a user interface enabling Seeker to populate a list of keywords into the KBS—total number of keywords allowed may or may not be capped at some finite value—such keywords populating only the subset universe generated by the above selected GCS. These keywords reflect the specific skills, experiences, personal qualities, etc. that the Seeker feels best reflect Seeker's skills for purposes of being matched with the best Provider, Element 302 of FIG. 3. During the keyword entry stage, system may dynamically—i.e., in real time—provide suggested bid assistance: for every keyword entered by Seeker, a graphical slider or similar graphical primitive may show the range of other Seekers' bids for that particular keyword and thus allow Seeker to make an informed bid for the particular keyword. Bid value is directly proportional to competition: as more Seekers input a particular keyword, the bid value required to appear above competitor Seekers increases.

Step 4: KMS. Having performed the above functions, the KMS may now perform a dynamic match between Providers' and Seekers' keywords. As the result of the matching operation, KMS may present Seekers with a list of relevant Providers whose keywords match those of Seekers within the same subset universe, ordered by keyword match percentage. Option to “expand” or “unroll” limited public profile listing: Seekers may view Provider's selected keywords, but Providers' selected values for “importance” may not be explicitly visible. Instead, keywords may be visible in discrete, qualitative groups, e.g., “Required,” “Nice to have,” or “Not important.” For example, for keyword “expert LAMP web developer” provided by Provider who assigned an importance value of “10” (assuming optional 10-point scale, where 10 is most important, and 0 is not important all), Seeker would see the keyword “expert LAMP web developer” appear in a category group called, for example, “Required” and “Expert” rather than “10” and “5.”

Step 5: Entry into Provider Applicant Pool, 506. Unlike Providers, above, when Seeker 501 and 502 clicks on Provider's profile 503, a connection is NOT made and thus a monetary transaction is NOT performed. Instead, Seeker now enters into Provider's Applicant Pool 504 and 505. Each Provider has its own Applicant Pool 506, a subset universe into which Seekers are entered upon clicking to connect with a Provider. This ensures that Providers are not overwhelmed by applicants, spamming, or scams.

Step 6: Provider Selection of Seeker(s) from Within Applicant Pool 506. Same as Providers, Steps 1-3, above. Now the process begins again as with Providers going after Seekers, but within the subset universe of the Applicant Pool 506.

Step 7: Seeker Review and Rating of Provider. Same as Providers, Step 4, above.

### Exemplary GPS-Capable Mobile Device Application(s)

In accordance with one or more embodiments of the invention, the described embodiments of the inventive system may be accessible and usable by all mobile devices, including and especially global positioning system-enabled (“GPS”) mobile devices. The location-based services (“LBS”) offered by the GPS functionality of mobile devices may allow users of the described embodiments of the inventive system to be immediately alerted to opportunity matches based upon user-specified time and location preferences. In one exemplary scenario, two users who are both matched by the described embodiments of the inventive system and are within close geographic proximity at the same time—e.g., both users are seated in or near the same café at the same time—may be immediately alerted to one another's presence by any one or more means, e.g., email, text message, phone call, etc., for the purpose of facilitating introductions between the two parties.

It should be noted that application of the concepts described herein is not limited only to job or talent matching. Similar methodology may be applied, for example, to social matching where people would use the described keywords with or without associated bid values to find friends. In this social matching example, the keywords would be used to describe interests of people, such as “cars” “travel,” etc.

### Exemplary Computer Platform

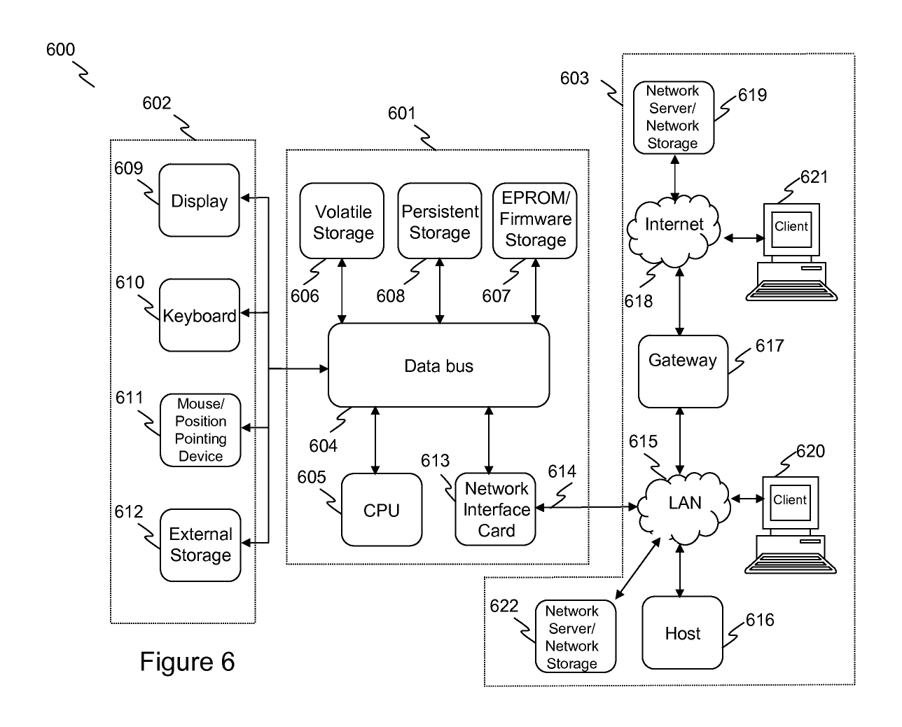

FIG. 6 illustrates an exemplary embodiment of a computer platform upon which the inventive system may be implemented.

FIG. 6 is a block diagram that illustrates an embodiment of a computer/server system 600 upon which an embodiment of the inventive methodology may be implemented. The system 600 includes a computer/server platform 601, peripheral devices 602 and network resources 603.

The computer platform 601 may include a data bus 605 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 605 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 605 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 605 to a display 609, such as a cathode ray tube (CRT), plasma display, or a liquid crystal display (LCD), for displaying information to a system administrator or user of the computer platform 601. An input device 610, including alphanumeric and other keys, is coupled to bus 601 for communicating information and command selections to processor 605. Another type of user input device is cursor control device 611, such as a mouse, a trackball, or cursor direction keys for communicating direction information and command selections to processor 605 and for controlling cursor movement on display 609. This input device typically has two degrees of freedom in two axes, a first axis (e.g., x) and a second axis (e.g., y), that allows the device to specify positions in a plane.

An external storage device 612 may be coupled to the computer platform 601 via bus 605 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 608. Volatile media includes dynamic memory, such as volatile storage 606.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 605. The bus 605 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 605. Communication interface 613 provides a two-way data communication coupling to a network link 615 that is coupled to a local network 615. For example, communication interface 613 may be an integrated services digital network (ISDN) card or a modem to provide a data communication connection to a corresponding type of telephone line. As another example, communication interface 613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 615 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients (other computers, mobile devices, or any Internet-connected devices) 620 and 621 may themselves be implemented based on the computer platform similar to the platform 601.

Local network 615 and the Internet 618 both use electrical, electromagnetic or optical signals that carry digital data streams. The signals through the various networks and the signals on network link 615 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 615 and communication interface 613. In the Internet example, when the system 601 acts as a network server, it might transmit a requested code or data for an application program running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the system for matching people or entities while creating disincentives to prevent people or entities from over-marketing themselves. It is intended that the specification and examples be considered as exemplary only, with a true scope and spirit of the invention being indicated by the following claims.

What is claimed is:

1. A computer-implemented system for matching a first entity from a first plurality of entities and a second entity from a second plurality of entities, the system comprising:
a. a first user interface portion for receiving at least one general requirement;
b. a second user interface portion for receiving at least one user-generated keyword being indicative of at least one characteristic of the first entity;
c. a third user interface portion for receiving a bid value or importance value corresponding to the at least one user-generated keyword;
d. a matching portion for generating a match results based on the general requirement, the at least one user-generated keyword and the bid value or importance value; and
e. a connection establishing portion for establishing a connection between the first entity and the second entity using the match results, wherein upon stabling the connection, the first entity and the second entity are each automatically charged an amount of money based on the bid value.

2. The computer-implemented system of claim 1, wherein the first plurality of entities are job candidates and the second plurality of entities are employers, and wherein the at least one user-generated keyword is indicative of a skill possessed by a job candidate.

3. The computer-implemented system of claim 1, wherein the third user interface portion generates a graphical primitive visualizing a current bid range for the at least one user-generated keyword.

4. The computer-implemented system of claim 3, wherein the graphical primitive is a sliding scale operable to visualize the current bid range for the at least one user-generated keyword and to receive the bid value corresponding to the at least one user-generated keyword.

5. The computer-implemented system of claim 1, further comprising a fourth user interface portion for receiving an importance value associated with the at least one user-generated keyword, wherein the match results generated by the matching portion are additionally based on the received importance value.

6. The computer-implemented system of claim 1, further comprising a fourth user interface portion for receiving an experience level value associated with the at least one user-generated keyword, wherein the match results generated by the matching portion are additionally based on the received experience level value.

7. The computer-implemented system of claim 1, wherein the first user interface portion receives a first user-generated keyword from a first entity and a second user-generated keyword from the second entity and wherein the matching portion generates the match results based on the first user-generated keyword and the second user-generated keyword, the at least one general requirement or(?) relative importance or experience level of the user-generated keywords.

8. The computer-implemented system of claim 1, wherein upon stabling the connection, a first information on the first party is provided to the second party and a second information on the second party is provided to the first party.

9. The computer-implemented system of claim 1, further comprising a pool management module for managing a connection pool of the second entity, wherein upon establishing the connection, the first entity is added to the connection pool.

10. The computer-implemented system of claim 1, further comprising a rating portion for receiving from the first entity a rating value assigned by the first entity to the second entity or from the second entity a rating value assigned by the second entity to the first entity.

11. The computer-implemented system of claim 1, wherein the match results comprise a graphical map representing the first plurality of entities and wherein the first entity, which submitted higher bid value to the third user interface appears more prominently on the graphical map than a third entity of the first plurality of entities, which submitted lower bid value to the third user interface.

12. The computer-implemented system of claim 1, further comprising a positioning portion for determining, after the connection between the first entity and second entity is established, current geographical locations of the first entity and second entity and alerting the first entity and second entity if the first entity and second entity are located in a geographical proximity of one another.

13. A computer-implemented method for matching a first entity from a first plurality of entities and a second entity from a second plurality of entities, the method comprising:
a. generating a first user interface portion for receiving at least one general requirement;
b. generating a second user interface portion for receiving at least one user-generated keyword being indicative of at least one characteristic of the first entity;
c. generating a third user interface portion for receiving a bid value corresponding to the at least one user-generated keyword;
d. generating a match results based on the general requirement, the at least one user-generated keyword and the bid value; and
e. establishing a connection between the first entity and the second entity using the match results, wherein upon stabling the connection, the first entity and the second entity are each automatically charged an amount of money based on the bid value.

14. The computer-implemented method of claim 13, wherein the first plurality of entities are job candidates and the second plurality of entities are employers and wherein the at least one user-generated keyword is indicative of a skill or interest possessed by a job candidate.

15. The computer-implemented method of claim 13, wherein generating the third user interface portion further comprises generating a graphical primitive visualizing a current bid range for the at least one user-generated keyword.

16. The computer-implemented method of claim 15, wherein the graphical primitive is a sliding scale operable to visualize the current bid range for the at least one user-generated keyword and to receive the bid value corresponding to the at least one user-generated keyword.

17. The computer-implemented method of claim 13, further comprising generating a fourth user interface portion for receiving an importance value associated with the at least one user-generated keyword, wherein the match results generated by the matching portion are additionally based on the received importance value.

18. The computer-implemented method of claim 13, further comprising generating a fourth user interface portion for receiving an experience level value associated with the at least one user-generated keyword, wherein the match results generated by the matching portion are additionally based on the received experience level value.

19. The computer-implemented method of claim 13, wherein the first user interface portion receives a first user-generated keyword from a first entity and a second user-generated keyword from the second entity and the match results are generated based on the first user-generated keyword and the second user-generated keyword, the at least one general requirement and relative importance of the user-generated keywords.

20. The computer-implemented method of claim 13, wherein upon stabling the connection, a first information on the first party is provided to the second party and a second information on the second party is provided to the first party.
